(19) United States
(12) Patent Application Publication
(10) Pub. No.: US 2017/0191293 A1
(43) Pub. Date: Jul. 6, 2017

(54) DOOR SECURITY DEVICE

(71) Applicant: SOS Systems, LLC, Butler, MO (US)

(72) Inventors: Justin Michael Osburn, Butler, MO (US); Lance Edward Sargent, Butler, MO (US)

(73) Assignee: SOS Systems, LLC, Butler, MO (US)

(21) Appl. No.: 15/394,055

(22) Filed: Dec. 29, 2016

Related U.S. Application Data
(60) Provisional application No. 62/272,898, filed on Dec. 30, 2015.

(51) Int. Cl. E05C 19/00

(52) U.S. Cl. CPC E05C 19/00

(57) ABSTRACT

A door security device and method for its use. The device includes a winch assembly disposed on a support bracket and with a cover that can be applied to enclose and secure the winch assembly. The device is mounted adjacent a door to be secured. The winch assembly includes a tether, a release lever, and a handle. The release lever provides a one-way ratcheting mechanism to restrict extension of the tether and is operable to release the tether. The handle is operable to retract the tether. A door loop installed on the door provides a secure feature for coupling with the tether. The handle and other safety implements may be stored within the cover. The device is deployable by coupling the tether to the door loop to secure a door against opening even when a door handle or lock on the door have been defeated.

### CROSS-REFERENCE TO RELATED APPLICATIONS

This application claims the benefit of U.S. Provisional Patent Application No. 62/272,898, filed Dec. 30, 2015 the disclosure of which is hereby incorporated herein in its entirety by reference.

### BACKGROUND

Terror threats and potential hostage situations have become more frequent in recent years. These threats often impact both public and private structures ranging from schools and colleges to businesses and many other dwellings that enclose a mass of people. In many cases, outside aggressors attempt to gain entry into the structure and/or into interior rooms in the structure through their associated doors. Such doors are typically only securable through a lock integrated into the handle or door knob and in some cases through a supplemental lock, e.g. a dead bolt or safety chain included on the door.

These locking mechanisms may not provide sufficient security against a determined intruder. The locks can often be overcome by simply breaking through a window in the door to gain access to the locking mechanism on the opposite side of the door. Or the handle or knob might be damaged or destroyed by the intruder to defeat the locking mechanism.

Other known door security devices include bars and jams or braces, among others. The Katy Bar, for example, lays across the door secured by two brackets, one on each side of the door frame. Problems with bars and braces are numerous. For example, bars and braces are generally only useable on doors that open into a room, can be removed by an intruder if the intruder gains access through a window in the door, cannot withstand a large amount of force, and they can be tampered with by occupants, such as children, to lock others out of the room when no threat is present.

A more secure means for locking a door against intrusion during a terror threat event is needed. Such a locking means that can be easily and quickly securable and that can secure both inward and outward opening doors would be beneficial.

### SUMMARY

Exemplary embodiments are defined by the claims below, not this summary. A high-level overview of various aspects thereof is provided here to introduce a selection of concepts that are further described in the Detailed-Description section below. This summary is not intended to identify key features or essential features of the claimed subject matter, nor is it intended to be used in isolation to determine the scope of the claimed subject matter. In brief, this disclosure describes a door-security device that is adaptable to any door, is securable against tampering, and that provides a storage location for additional safety equipment.

The door-security device comprises a winch assembly disposed on a support bracket. A cover is provided that is securable to the support bracket to enclose the winch assembly and prevent tampering therewith. Additional space may be provided within the cover for storage of components of the winch assembly as well as other items that may be used during a crisis event.

The winch assembly includes a hand-operated winch. A winch cable is disposed on the winch and can be drawn from the winch by hand for coupling with a door loop. A handle is coupleable to an axle of the winch and is moveable to retract and tighten the cable. A ratcheting mechanism is associated with the axle to enable rotation in one direction and to selectively resist rotation in the opposite direction. A release lever is also provided to disengage the ratcheting mechanism for quick and easy release of winch cable by users both young and old. The door loop is securable to a door and provides a feature to which a free end of the winch cable can be easily and securely coupled.

In use, the door-security device is mountable to a wall or floor at a location that is a sufficient distance from a door opening to prevent an intruder from being able to access the device. During periods of non-use, the cover is disposed on the support bracket to cover the winch assembly and any stored items. The cover may be locked to avoid the winch or other items stored therein from being tampered with by, for example, young children. To deploy the door-security device, the cover is removed and the winch cable is extended. A hook at the distal end of the cable is coupled with the door loop. The axle of the winch is then rotated via the handle to tighten the cable to a desired extent and secure the door against being opened.

### DESCRIPTION OF THE DRAWINGS

Illustrative embodiments are described in detail below with reference to the attached drawing figures, and wherein:

FIG. 1 is perspective, partially exploded view of a door security device with a safety cover removed depicted in accordance with an exemplary embodiment;

FIG. 2 is an exploded perspective view of a door loop to be installed on a door depicted in accordance with an exemplary embodiment;

FIG. 3 is a perspective view of the door security device of FIG. 1 installed on a wall and with the safety cover partially removed depicted in accordance with an exemplary embodiment;

FIG. 4 is a perspective view of the door security device of FIG. 1 installed on a wall with the safety cover removed and with a winch cable coupled to an outwardly opening door depicted in accordance with an exemplary embodiment;

FIG. 5 is a perspective view of the door security device of FIG. 1 installed on a floor with the safety cover removed and with a winch cable coupled to an outwardly opening door depicted in accordance with an exemplary embodiment;

FIG. 6 is a perspective view of the door security device of FIG. 1 installed on a wall with the safety cover removed and with a winch cable extended to secure a set of double doors depicted in accordance with an exemplary embodiment;

FIG. 7 is a perspective view of the door security device of FIG. 1 installed on a wall with the safety cover removed and with a winch cable extended to secure an inwardly opening door; and

FIG. 8 is a partially exploded perspective view of another door security device depicted in accordance with an exemplary embodiment.

### DETAILED DESCRIPTION

The subject matter of select exemplary embodiments is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The terms “about” or “approximately” as used herein denote deviations from the exact value by +/−10%, preferably by +/−5% and/or deviations in the form of changes that are insignificant to the function.

Exemplary embodiments are described herein with respect to the drawings in which reference numerals are employed to identify particular components or features. Similar elements in the various embodiments depicted are provided with reference numerals having matching second and third digits but with differing first digits, e.g. element 10 is similar to elements 110, 210, etc. Such is provided to avoid redundant description of similar features of the elements but is not intended to indicate the features or elements are necessarily the same.

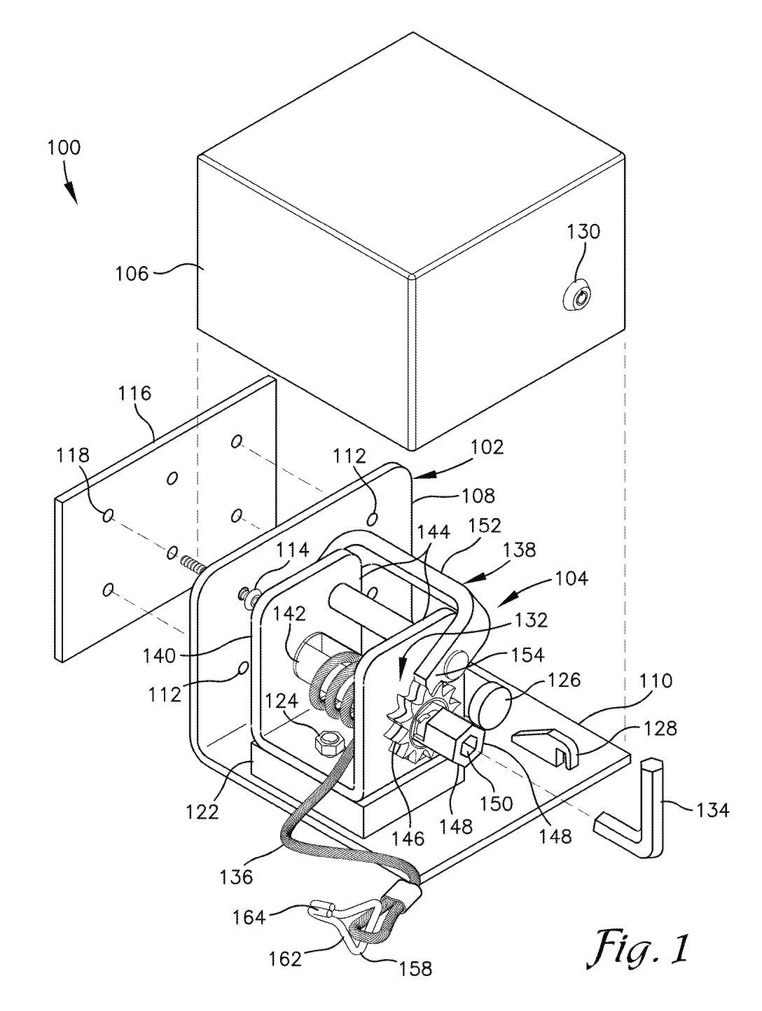

With reference to FIGS. 1-4, a door security device 100 is described in accordance with an exemplary embodiment. The door security device 100 includes a support bracket 102 on which a winch assembly 104 and a housing or cover 106 can be disposed. The support bracket 102 comprises a wall plate 108 and a base plate 110 that are substantially planar and arranged generally perpendicularly to one another to provide the support bracket 102 with an L-shaped profile. The wall plate 108 includes a plurality of apertures 112 through which fasteners 114 can be inserted for coupling the support bracket 102 to a wall 10 or similar rigid surface.

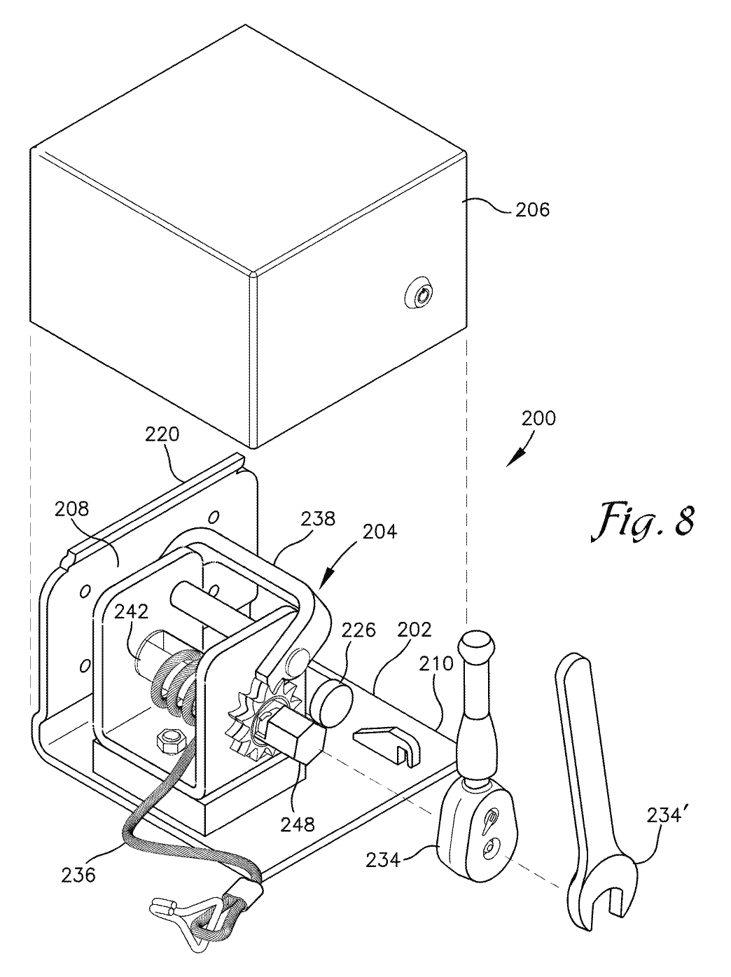

A spacer plate 116 may be provided for installation between the wall plate 108 and the wall 10. The spacer plate 116 includes a plurality of apertures 118 that align with the apertures 112 of the wall plate 108 to receive the fasteners 114. The spacer plate 116 has dimensions that are smaller than those of the wall plate 108 in at least one direction and has a thickness that provides a space between the wall plate 108 and the wall 10 that is sufficient to receive at least a portion of a flange or similar structure of the cover 106 therein. In another embodiment depicted in FIG. 8, a wall plate 208 may include an upper portion 220 that is slightly angled or offset to extend out of the plane of the remainder of the wall plate 208. The angle or offset provides a space between the upper portion 220 and the wall 10 that is sufficient to receive the flange of the cover 106 therein. In another embodiment, side portions configured like the upper portion 220 but disposed along side edges of the wall plate 208 may be similarly employed in addition to or instead of the upper portion 220.

With continued reference to FIGS. 1-4, the base plate 110 includes a pedestal 122 extending upwardly from a top surface of the base plate 110. The pedestal 122 raises the winch assembly 104 above the base plate 110 to provide sufficient clearance for operation of the winch assembly 104 as described more fully below. In some embodiments, like that shown in FIG. 8, the pedestal is not included.

The pedestal 122 may be formed integrally with the base plate 110 or may be coupled thereto, such as by welding or fasteners. As a separate component that is coupled to the base plate 110, the pedestal 122 may comprise a section of hollow square tubing or solid bar or be constructed otherwise, e.g. from a plurality of smaller component parts that are welded together to form a tubular or cuboidal component. Although not shown, if constructed from a hollow tubing the pedestal 122 may include a top and/or bottom wall with one or more apertures therethrough for receiving fasteners 124 for coupling with the base plate 110 and/or the winch assembly 104. Similar apertures may be provided in the pedestal 122 when formed from a solid bar or an otherwise constructed component. Alternatively or in addition, the coupling between the pedestal 122 and the base plate 110 and/or the winch assembly 104 may be completed by welding or similar joining means.

In some embodiments, the base plate 110 includes additional space along one or more sides of the pedestal 122 for storage of components of the door security device 100 or for additional security implements 126. Such implements may include, for example and not limitation, a canister of pepper spray or mace, a weapon, a communication device, or food, among others. The base plate 110 also includes a locking tab 128 or similar feature configured for engagement by a locking arm of a lock 130 provided on the cover 106.

The winch assembly 104 comprises a hand operated winch that includes a ratcheting mechanism 132, a handle 134, a tether 136, and a release lever 138. In other embodiments, the winch assembly 104 may comprise an electrically operated winch or may include a spring-loaded or biased retraction method that operates to automatically retract or apply tension on the tether 136.

The winch assembly 104 includes a body 140 configured to support the release lever 138 and an axle 142 on which the tether 136 may be wound or coiled. The axle 142 extends through sidewalls 144 of the body 140 and carries a ratchet-gear 146 on at least one end thereof; a ratchet-gear 146 may be provided on both ends of the axle 142. The ratchet-gear 146 is positioned on the axle 142 adjacent the sidewall 144 and between sidewall 144 and a distal end of the axle 142. The distal end of the axle 142 may be directly coupled to the handle 134, such as by welding or may include a handle-coupler 148 that is adapted to couple to the handle 134.

The handle-coupler 148 may be integral with the axle 142 or may be affixed to the distal end of the axle 142. In one embodiment, the handle-coupler 148 is selectively coupleable to each end of the axle 142 to enable the winch assembly 104 to be disposed on the base plate in a left or a right facing orientation and the handle-coupler 148 coupled to the appropriate end of the axle 142. In another embodiment, the axle 142 is selectively oriented and disposed in the body 140 based on a desired orientation of the winch assembly 104, e.g. the axle 142 is oriented to extend further from the body 140 on one side to enable provision of or coupling with the handle-coupler 148 on an appropriate side of the winch assembly 104.

The handle-coupler 148 provides a blind bore 150 extending coaxially with the axle 142 and configured to receive a first end of the handle 134. The blind bore 150 and/or the first end of the handle 134 may include one or more mating facets to resist rotational movement of the handle 134 relative to the handle-coupler 148. The handle 134 may be retained in engagement with the handle-coupler 148 by, for example, a setscrew that is threadably installed in the handle-coupler 148 and tightened to impinge on the handle 134 disposed therein. It is understood that one of skill in the art will recognize other ways of coupling the handle 134 with the handle-coupler 148, including, for example welding or joining the handle 134 with the handle-coupler 148; such other ways are within the scope of embodiments described herein. In one embodiment, the handle 134 is integral with the axle 142, e.g. a portion of the axle 142 extending beyond the ratchet-gear 146 is bent or turns approximately 90° and extends a sufficient distance to form the handle 134.

In another embodiment depicted in FIG. 8, a handle-coupler 248 or the distal end of the axle 242 is provided with a cross-sectional profile configured for engagement by a tool 234 that functions as the handle for the winch assembly 204. The tool 234 may be configured similarly to a socket wrench or ratchet tool known in the art that is removeably engageable with the handle-coupler 248. For example, the tool 234 may include a socket that is sized to engage a hex-end of the handle-coupler 248 or of the axle 242, or the handle-coupler 248 or the distal end of the axle 234 may include a receiver configured to receive shaft carried by the tool 234. In another embodiment, the shaft of the tool 234 may be fixedly or non-removeably coupled to the axle 242 or handle-coupler 248. The ratcheting mechanism of the tool 234 is preferably adapted to rotate the axle 242 only in a direction that retracts the tether 236 of the winch assembly 204; rotation of the tool 234 in the opposite direction does not operate to rotate the axle 242. Alternatively, a tool 234′ configured similarly to an open- or close-ended wrench may be provided, as depicted in FIG. 8. The tools 234 and 234′, when uncoupled from the handle-coupler 248 or the axle 242 may be stored on the base plate 210 and inside the cover 206.

Returning to FIG. 1, the release lever 138 is pivotably coupled to the body 140 of the winch assembly 104, and provides a grip 152 and an arm 154 that extends into engagement with the ratchet-gear 146. The release lever 138 is biased to pivot counter-clockwise (as shown in FIG. 1) such that the arm 154 is biased toward engagement with the ratchet-gear 146. The engagement between the arm 154 and the ratchet-gear 146 is configured to provide a one-directional ratcheting operation that controls retraction and extension of the tether 136.

Counter-clockwise rotation of the axle 142 to retract the tether 136 is enabled by pivoting the release lever 138 clockwise about its coupling with the body 140 and against the bias thereon. The interaction between teeth of the ratchet-gear 146 and the arm 154 pivot the release lever 138 clockwise to allow each tooth to pass by the arm 154 as the axle 142 is rotated counter-clockwise. The bias on the release lever 138 acts to pivot the release lever 138 counter-clockwise to return the arm 154 into engagement between the next adjacent teeth of the ratchet gear 146.

Clockwise rotation of the axle 142 to extend the tether 136 is prevented by the engagement of the arm 154 with the ratchet-gear 146. To enable the tether 136 to be extended from the winch assembly 104, a force is applied to the grip 152 to pivot the release lever 138 clockwise about its coupling with the body 140 and to move the arm 154 out of engagement with the ratchet-gear 146. The bias on the release lever 138 returns the arm 154 into engagement with the ratchet-gear 146 upon release of the force applied to the grip 152.

The tether 136 comprises an elongate, non-extensible member such as a cable, chain, strap, or the like. The tether 136 is sufficiently flexible to enable coiling the tether 136 around the axle 142 and to bend around obstructions that may exist between the winch assembly 104 and a door 156 to be secured, such as a door jamb as depicted in FIG. 4. The tether 136 is preferably resistant to stretching, abrasion, or other damage that might allow the tether 136 to be disengaged from the door 156 or severed to allow the door 156 to be opened. The tether 136 can be coupled to the axle 142 by any desired means that are sufficient to prevent decoupling during a crisis situation, e.g. when the tether 136 is placed under tension between the winch assembly 104 and a door and when an intruder applies a force on the door, such as by kicking or ramming the door. Any length of the tether 136 may be provided that is sufficient to extend between the winch assembly 104 and the door 156.

A hook 158 is provided at a distal end of the tether 136. The hook 158 may comprise any form configured to engage a door loop 160 mounted on the door 156. As depicted in FIGS. 1-4 the hook 158 comprises a rigid rod that is bent or formed to provide an eyelet 162 through which the tether 136 is fed and coupled around and a hook portion 164 that is adapted to engage the door loop 160. In another embodiment, the hook 158 comprises a carabiner, a D-ring, a sling hook, a grab hook, or a foundry hook, which may include a gate to secure the coupling of the hook 158 with the door loop 160.

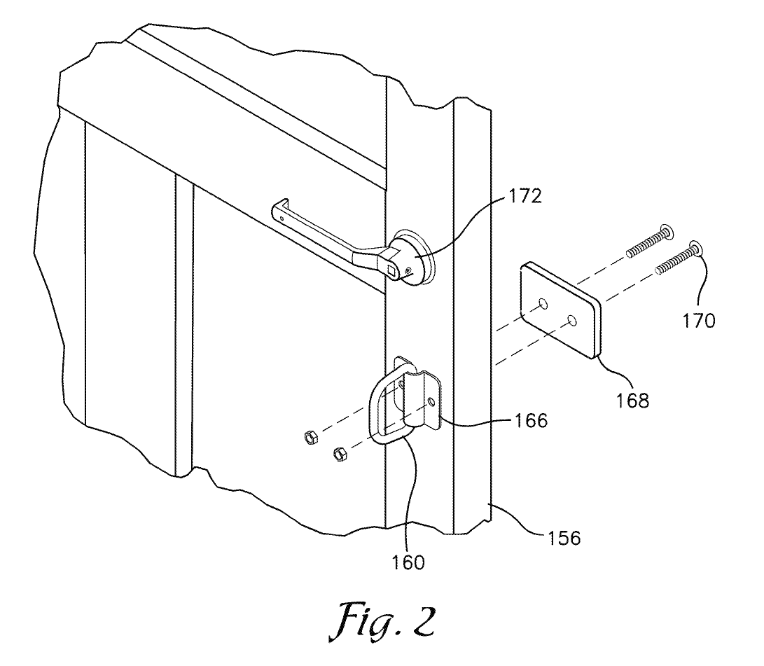

As depicted in FIG. 2, the door loop 160 comprises a rigid ring that is affixed to the door 156. The door loop 160 is affixed to the door 156 by a mounting plate 166 that includes a recess in which the loop 160 is received and trapped between the mounting plate 166 and the door 156. A reinforcement plate 168 is disposed on an opposite side of the door 156 and a pair of fasteners 170 are disposed through the reinforcement plate 168 and the mounting plate 166 to secure the assembly to the door 156. It is understood that one of skill in the art will recognize a variety of other ways for affixing the door loop 160 on the door 156 or integrating the door loop 160 into the door 156; such configurations are within the scope of embodiments described herein. In another embodiment, the door loop 160 is provided as part of a door handle 172 on the door 156 or the tether 136 is coupled directly to the door handle 172.

The cover 106 comprises a plurality of walls configured to couple to and enclose a space around the winch assembly 104. As depicted in FIG. 1, the cover 106 comprises four walls that when coupled to the support bracket 102 forms a hollow cuboidal form. It is however understood, that the cover 106 may take a variety of configurations without departing from the scope described herein. The lock 130 may be provided on the cover 106 and located to operatively engage the locking tab 128 on the support bracket 102 to secure the cover 106 on the support bracket 102. The cover 106 is preferably formed from a rigid material to prevent its removal and/or damage thereto that may provide unwanted access to the winch assembly 104, such as by young children. The cover 106 may be provided with rounded corners and/or padded surfaces to reduce the risk of injury caused by contacting the cover 106, e.g. injury caused by a young child running into the cover 106. In some embodiments, the cover may not be needed or wanted and the door security device 100 may be employed without the cover 106. In such embodiments, other methods for securing the winch assembly 104 against tampering may be used.

The lock 130 may utilize any available locking mechanism to secure the cover 106 to the support bracket 102 as well as any available access method for operating the lock 130. Access methods such as a key, combination lock, or similar mechanical means as well as electronic means such as fingerprint scanners or voice identification mechanisms may be employed.

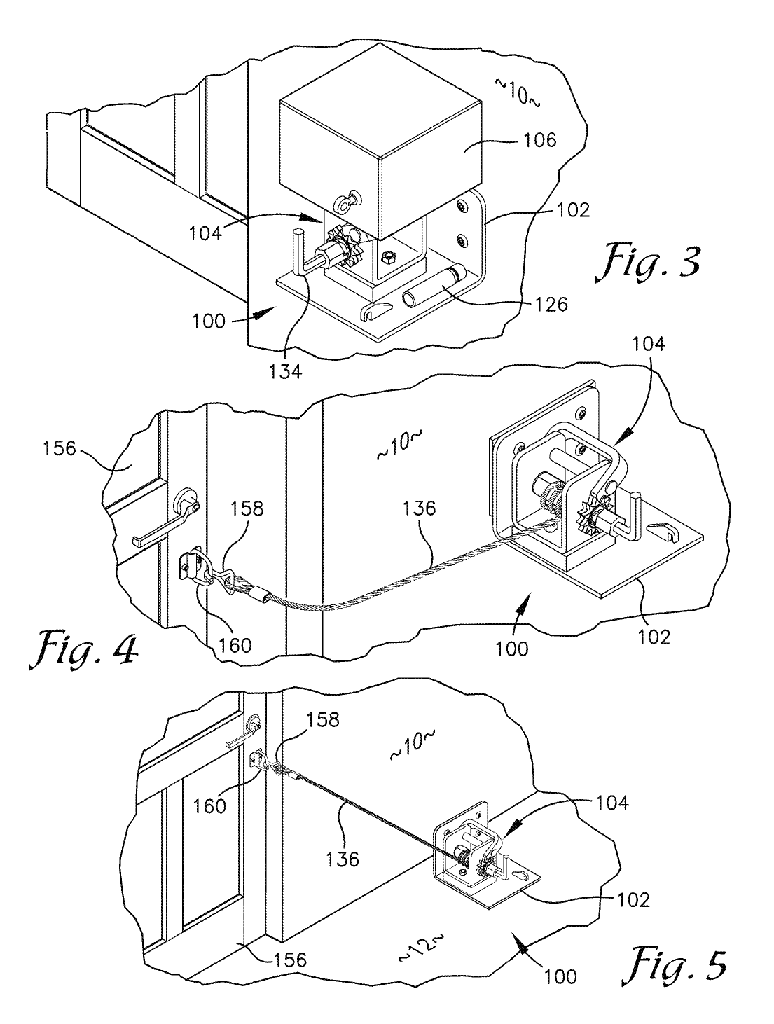

With continued reference to FIGS. 1-4, installation and operation of the door security device 100 is described in accordance with an exemplary embodiment. The configuration of the door security device 100 enables installation on the wall 10 as depicted in FIGS. 3, 4, 6, and 7. The device 100 can be mounted at any height along the wall 10, but it is generally preferable for the device 100 to be mounted at a height that is generally equal to that of the door handle 172 and/or the height of the door loop 160. Such a mounting position may provide the greatest ease of operation for users of all heights. This mounting height may also provide the most direct application of the tension force on the door 156 and an optimal position on the door 156. For example, mounting the device 100 and the door loop 160 near the top of the door 156 make operation of the device 100 by shorter individuals more difficult and may leave the bottom of the door 156 somewhat more vulnerable to attack by an intruder. The door security device 100 may also be mounted on a floor 12, typically, but not necessarily, adjacent or abutting the wall 10, as depicted in FIG. 5. In another embodiment, the device 100 might be mounted within the wall 10 or the floor 12 in a compartment formed therein.

The door security device 100 should be mounted on the wall 10 or the floor 12 a distance away from the door 156 that is sufficient to prevent an intruder from reaching the device 100 through the door 156. For example, if the door 156 includes a window, the device 100 should be mounted far enough away from the door 156 that an intruder extending an arm through the window cannot reach the device 100. The door security device 100 is also preferably mounted away from any access openings in the wall 10, e.g. windows or the like. The door security device 100 should be located on the wall 10 or floor 12 at a location associated with structural members in the wall 10 or floor 12 or where the fasteners 114 retaining the support bracket 102 can be sufficiently secured in the wall 10 or floor 12 to resist forces that may be applied on the door security device 100 during use thereof.

With reference to FIG. 3, in times of non-use the door security device 100 is mounted on the wall 10 or the floor 12 and the cover 106 is disposed thereon and locked. Locking of the device 100 in this manner prevents unauthorized access to the device 100 and any items stored within the cover 106. For example, young children or students are prevented from accessing, tampering with, and/or deploying the winch assembly 104 as well as any items stored within the cover 106. As such, all items stored within the cover 106 are secured and can be accounted for when their need arises. This may also enable security implements 126 that may comprise hazardous items, such as mace, pepper spray, guns, weapons, or the like to be safely stored within the cover 106 and available for use by an authorized user during a crisis situation. In one embodiment, the door security device 100 is provided or sold as a lockable security kit that includes one or more security implements 126 along with the winch assembly 104 which are both safely locked inside the cover 106. One or more features configured to releasably retain the security implements 126 may be provided on the wall plate 108, the base plate 110, or on an inside surface of the cover 106.

Authorized users are provided with keys to the locks 130 or otherwise given access to open the locks 130. Authorized users may comprise anyone that may be responsible for operating the door security device 100 in a time of crisis. For example, in a school setting, authorized users may include teachers, office staff, custodians, security guards, or the like. The locks 130 may be configured to accept a common key or may each be uniquely keyed.

Upon activation of a security protocol in which the door security device is to be employed, such as when an intruder has entered a premises, the door 156 is closed and preferably locked if a door lock is available. An authorized user unlocks the lock 130 and removes the cover 106 as depicted in FIG. 3. The release lever 138 is depressed to disengage the arm 154 from engagement with the ratchet-gear 146, and the tether 136 is pulled to extend a sufficient length of the tether 136 from the winch assembly 104 to reach the door loop 160. In some embodiments, the tether 136 may be coiled or otherwise bundled and stored next to the winch assembly 104 inside the cover 106; the proximal end of the tether 136 is however coupled to the axle 142. As such, the tether 136 need not be unwound or pulled from the winch assembly 104 while depressing the release lever 138.

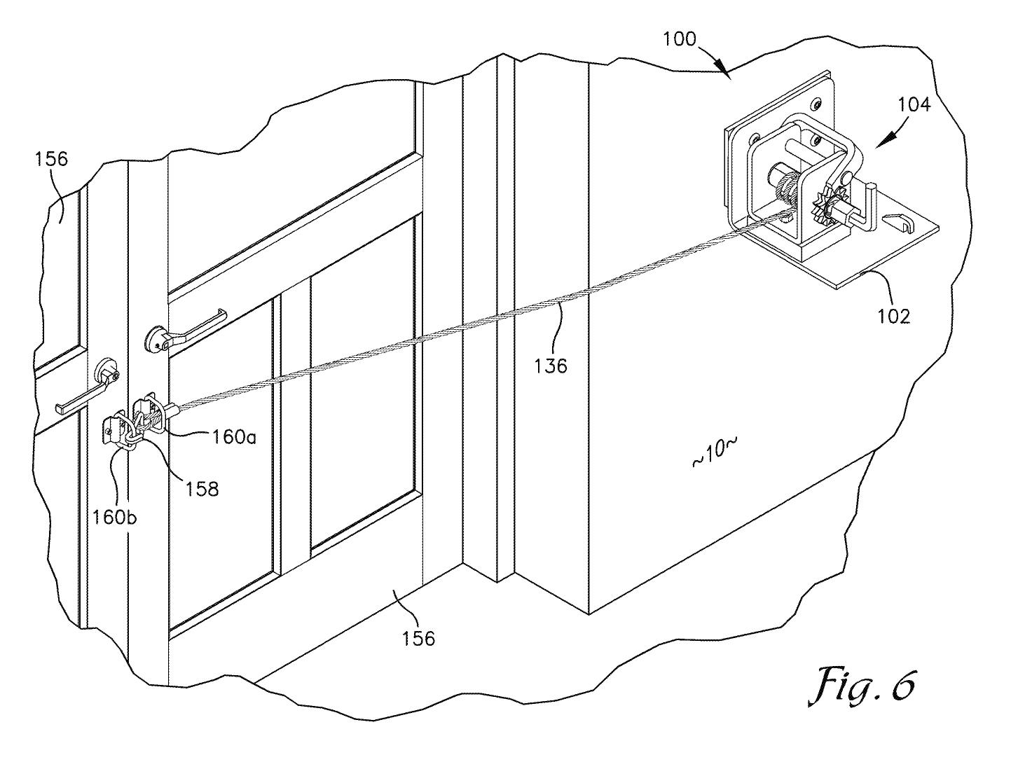

The hook 158 is coupled to the door loop 160. As depicted in FIGS. 4 and 5, on an outwardly opening single door 156, the hook 158 is directly coupled to the door loop 160. As depicted in FIG. 6, when the door security device 100 is to be employed for securing outwardly opening double doors 156, a door loop 160 is mounted on each of the doors 156. The hook 158 and the tether 136 are then threaded through the door loop 160a nearest the device 100, and the hook 158 is coupled to the further away door loop 160b.

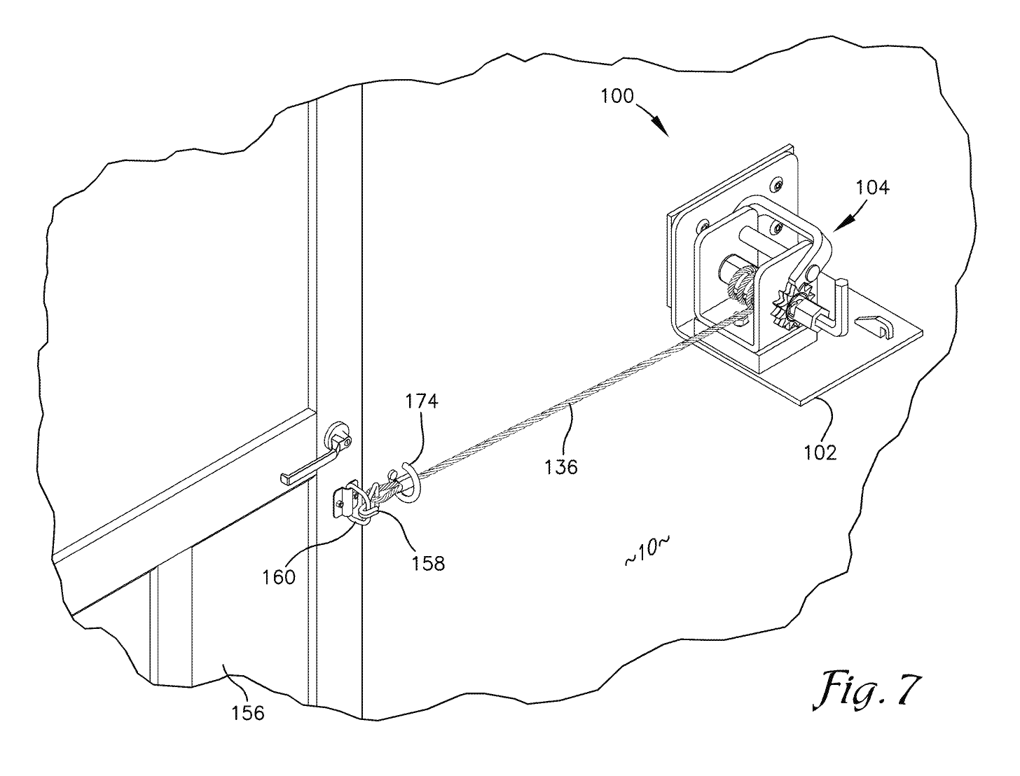

For an inwardly opening single door 156, a retaining eye 174 is provided, as depicted in FIG. 7. The retaining eye 174 comprises looped or hooked feature in which the tether 136 can be disposed and retained in close proximity to the wall 10. As depicted in FIG. 7, the retaining eye 174 comprises a threaded screw with a hook extending from a head thereof. When installed in the wall 10, the retaining eye 174 leaves only the hook extending from the wall 10. The tether 136 can thus be threaded through or placed into the hook of the retaining eye 174. It is understood that the retaining eye 174 may take a variety of other forms, such as a bracket, a carbineer, a door loop 160, or similar device that can be coupled to the wall 10 adjacent the door 156. Thus operation of the device 100 for an inwardly opening door 156 includes disposal of the tether 136 into the retaining eye 174 and coupling of the hook 158 with the door loop 160. The retaining eye 174 resists the door 156 from being opened inwardly substantially beyond the location of the retaining eye 174.

For inwardly opening double doors 156 and/or multiple side-by-side sets of doors 156, the hook 158 and tether 136 are threaded through door loops 160 mounted on each door 156 and the hook 158 is coupled to a door loop 160 mounted on the wall 10 on the opposite side of the doors 156.

The handle 134 is rotated, counter-clockwise as depicted in FIG. 1, to retract any excess length of the tether 136 and to place the tether 136 under tension between the winch assembly 104 and the door loop 160. The tether 136 is placed under sufficient tension to secure the door 156 against movement. The ratcheting mechanism provided by the release lever 138 and the ratchet-gear 146 prevents rotation of the handle 134 in the wrong direction. This may aid proper operation during a crisis situation when the user may be under duress and not thinking clearly. In some embodiments, the handle 134 is decoupleable from the axle 142 or the handle-coupler 148, as depicted in FIG. 8. In such embodiments, the handle 134, 234, or 234′ is stored on the base plate 110 or otherwise within the confines of the cover 106. The handle 134, 234, 234′ thus is first retrieved from its storage position and coupled to the axle 142, 242 or the handle-coupler 148, 248 prior to rotating.

The pedestal 122 provides sufficient clearance between the winch assembly 104 and the base plate 110 to enable the handle 134 to be rotated in a full circle. In embodiments, like that shown in FIG. 8, which employ a removable ratchet-style handle 234 or a wrench-style handle 234′, full rotation of the handle 234, 234′ is obstructed by the base plate 210. As such, the ratchet-style handle 234 includes a ratcheting mechanism that allows the handle 234 to be rotated counter-clockwise to retract the tether 236 and then rotated clockwise without rotating the axle 242 to reset the position of the handle 234 for additional counter-clockwise rotations. The wrench-style handle 234′ does not include a ratcheting mechanism and thus must be decoupled from the axle 242 or handle-coupler 248 following each counter-clockwise rotation, repositioned, and recoupled to the axle 242 or handle-coupler 248 to provide subsequent counter-clockwise rotations.

When under tension, the tether 136 resists opening of the door 156 irrespective of the condition of the door handle 172 and any windows or other openings in the door 156. Because the tether 136 is coupled to the door loop 160 and not the door handle 172, an intruder can defeat the handle 172, such as by breaking the handle off the door 156 but will still be prevented from opening the door 156 by the door security device 100. Similarly, if the intruder gains access through the door 156 by, for example, breaking out a window or panel of the door 156, the intruder may be able to unlock the door handle 172 but will find it very difficult to defeat the door security device 100. The tension on the tether 136 is preferably sufficient to substantially prevent the intruder from decoupling the hook 158 from the door loop 160 and the winch assembly 104 is preferably mounted a sufficient distance from the door 156 to prevent the intruder from reaching the release lever 138 to release the tension on the tether 136.

Upon cessation of the crisis situation, the door security device 100 can be disarmed and returned to the storage condition. To release the tether 136, the release lever 138 is pivoted clockwise by providing a downward force on the grip 152 to disengage the arm 154 from the ratchet-gear 146. The axle 142 can then be freely moved to feed out a sufficient length of the tether 136 to enable decoupling of the hook 158 from the door loop 160. The release lever 138 is then released and the handle 134 rotated to retract and coil the tether 136 onto the axle 142. Alternatively, the tether 136 can be bundled and disposed adjacent the winch assembly 104 on the base plate 110. Any components or other items removed from the base plate 110, such as the handle 234, 234′, or the security implements 126 may be replaced in their respective locations on the base plate 110. The cover 106 is then returned to its position on the support bracket 102 and the lock 130 locked.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to be inclusive of structures and arrangements or designs thereof that are within the scope of this disclosure and readily identifiable by one of skill in the art and that can perform the particular function in a similar way. Certain features and sub-combinations are of utility and may be employed without reference to other features and sub-combinations and are contemplated within the scope of the claims.

What is claimed is:

1. A door security device comprising:
a support bracket that is coupleable to one or more of a wall and a floor adjacent a door;
a winch assembly fixedly coupled to the support bracket, the winch assembly including an axle with a tether coupled thereto, a release lever pivotably coupled to a body of the winch assembly and biased into engagement with a ratchet-gear associated with the axle to obstruct rotation of the axle in a first direction, and a handle adapted to rotate the axle in an opposite second direction;
a coupler disposed on a distal end of the tether;
a door loop fixedly coupled to the door and being engageable by the coupler; and
a cover that is removeably disposed on the support bracket, the winch assembly being enclosed between the cover and the support bracket.

2. The door security device of claim 1, wherein the support bracket further comprises:
a wall plate; and
a base plate arranged to extend generally perpendicularly from the wall plate, the winch assembly being disposed on the base plate.

3. The door security device of claim 2, further comprising:
a pedestal disposed on the base plate between the base plate and the winch assembly, the pedestal providing a spacing between the base plate and the winch assembly sufficient to allow the handle to perform a complete rotation without contacting the base plate.

4. The door security device of claim 1, wherein the handle is fixedly coupled to the winch assembly.

5. The door security device of claim 1, wherein the handle is removeably coupled to the winch assembly, and wherein the handle is decoupled from the winch assembly and stored on the support bracket.

6. The door security device of claim 1, wherein the handle includes a ratcheting mechanism.

7. The door security device of claim 1, further comprising:
a security implement disposed on the support bracket and stored within the cover.

8. The door security device of claim 1, wherein the cover includes a lock configured to resist removal of the cover from the support bracket.

9. The door security device of claim 1, wherein the cover is removed, the coupler is engaged with the door loop, and the tether is placed under tension between the winch assembly and the door loop by rotation of the handle in the second direction, and wherein the door is prevented from being opened a distance sufficient for a person to pass by.

10. The door security device of claim 1, further comprising:
a retaining eye configured to receive and retain the tether therein and disposed on the wall adjacent the door, the retaining eye retaining the tether in close proximity to the wall.

11. A method for securing a door with a door security device, the method comprising:
withdrawing a tether from the door security device, the door security device including a support bracket coupled to one of a wall and a floor adjacent to the door and a winch assembly affixed to the support bracket, the tether being coupled to the winch assembly;
engaging a coupler on the end of the tether with a door loop disposed on the door;
rotating a handle of a winch assembly to retract the tether and to place the tether in tension between the winch assembly and the door loop.

12. The method of claim 11, further comprising:
removing a cover from engagement with the support bracket, the cover enclosing the winch assembly between the cover and the support bracket.

13. The method of claim 12, further comprising:
unlocking a lock on the cover to enable removal from the support bracket.

14. The method of claim 11, further comprising:
storing the handle on support bracket, the handle being decoupled from the winch assembly;
obtaining the handle from the storage location on the support bracket; and
coupling the handle to the winch assembly.

15. The method of claim 11, further comprising:
pivoting a release lever on the winch assembly to disengage an arm of the release lever from a ratchet-gear associated with an axle of the winch assembly to release tension on the tether; and
disengaging the coupler on the tether from the door loop.

16. The method of claim 11, further comprising:
storing one or more security implements on the support bracket.

17. The method of claim 11, further comprising:
disposing the tether in a retaining eye affixed to the wall adjacent to the door.

18. The method of claim 11, wherein the door comprises a first door and a second door disposed side-by-side and hinged to open along a common edge, wherein a first door loop is disposed on the first door and a second door loop is disposed on the second door, and wherein engaging the coupler on the end of the tether with the door loop disposed on the door further comprises:
threading the tether through the first door loop; and
engaging the coupler on the tether with the second door loop.

19. A method for securing a door with a door security device, the method comprising:
affixing a support bracket on one of a wall and a floor adjacent the door, the support bracket being disposed in a position that is unreachable by an intruder reaching through the door;
attaching a winch assembly to the support bracket, the winch assembly including an axle on which a tether can be coiled, a release lever that is pivotably coupled to a body of the winch assembly and including an arm that is biased into engagement with a ratchet-gear associated with the axle, and a handle that is useable to rotate the axle in a first direction to retract and coil the tether onto the axle, the engagement of the arm of the release lever and the ratchet-gear resisting rotation of the axle in an opposite second direction;
installing a door loop on the door, the door loop comprising a rigid loop to which a hook on a distal end of the tether can be coupled;
extending the tether from the winch assembly;
coupling the hook on the distal end of the tether with the door loop; and
rotating the handle in the first direction to place the tether in tension.

20. The method of claim 19, further comprising:
removing a cover disposed on the support bracket, the cover enclosing the winch assembly between the cover and the support bracket.
